(19) United States
(12) Patent Application Publication
(10) Pub. No.: US 2006/0091147 A1
(43) Pub. Date: May 4, 2006

(54) Lid dispenser

(76) Inventor: C. Robert Arndt, Poplar Bluff, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/267,897

(22) Filed: Nov. 4, 2005

Related U.S. Application Data
(60) Provisional application No. 60/625,292, filed on Nov. 4, 2004.

(51) Int. Cl. B23Q 7/04; B65G 59/00; B65H 3/00; G07F 11/16

(52) U.S. Cl. 221/208

(57) ABSTRACT

The present invention relates to a lid dispenser for lids which fit on disposable cups used for soda, milkshakes, coffee and the like. The dispenser receives a stack of lids in a lid stack holder mounted on a lid dispensing block. The lid stack holder has a hole in its base allowing the stack of lids to rest on the floor of the lid dispensing block. The block has an ejection arm which when activated dispenses one lid through an exit port onto a tray.

### CROSS REFERENCE TO RELATED APPLICATIONS

This application is based upon Provisional Patent Application 60/625,292 filed Nov. 4, 2004 and claims the priority thereof.

### STATEMENT REGARDING FEDERALLY SPONSORED RESEARCH OR DEVELOPMENT

Not Applicable

### BACKGROUND OF THE INVENTION

With the advent of plastic and methods of treatment of paper to make paper liquid resistant, disposable beverage containers are utilized at the rate of millions per day. Typical beverages are soda, coffee, milkshakes and the like. Fast food restaurants use such containers or cups in a variety of sizes perhaps as many as five or six different sizes at the same restaurant. Lids are provided to fasten about the rim of the container or cup. When such lids are applied to the disposable cup the liquid in the container is not apt to spill. Conventional lids are a thin plastic circular in shape and have a lip which fits snuggly over the rim of the cup. Most lids have a cut portion near the center of the lid where a drinking straw can be inserted through the cut portion.

The restaurant or shop owner receives the lids in a long container where the lids are stacked one upon the other in the interior of the container. When providing the lids for the consumer, the owner conventionally provides a box or a bin or the like and merely places the lids therein. The consumer must remove a lid from the bin and frequently has to handle several lids in order to free one lid from the bin resulting in the consumer handling several lids when procuring only one.

The handling of the lids provides a problem with respect to sanitation for other consumers. It would be desirable to have a dispenser which could dispense the lids one at a time.

The present invention relates to a lid dispenser which dispenses lids, one at a time, for beverage cups of a disposable nature.

### BRIEF SUMMARY OF THE INVENTION

The present invention provides a lid dispenser for non-nesting lids which has a holder for a stack of lids (lid stack holder) mounted on a lid dispensing block. The lid dispensing block has a push lever for a pivoting ejection arm. The arm has an arcuate shape to guide a lid to an exit port for ejection from the dispensing block through an exit port. In other words, this lid dispenser provides a means for dispensing one lid at a time with the consumer touching only the single dispensed lid. After pushing the lever on the pivoting ejection arm to dispense a lid the arm is returned to its start position by a spring or like mechanism.

The lid dispenser may have a door mounted on hinges on the front of the lid stack holder allowing the refilling of the dispenser where the stack of lids may be almost depleted. Preferably the door has a slot in the front so that the person responsible for refilling the lid dispenser can see how many lids are in the dispenser without having to open the door. Also the lid dispenser may bear a label on the front of the dispenser clearly stating the size of the lid in the dispenser. Such designations can also be made above or below the lid dispenser or in other convenient locations.

When the lid is dispensed from the dispenser it preferably lands on a tray whereby it is convenient for the consumer to pick up the lid and continue with securing his particular cup with its cover. The tray to receive dispensed lids preferably has a rim about the front portion so that the lid will not travel beyond the front portion of the tray. When ejected from the dispenser.

The ejection arm which ejects a single lid from the stack of lids through the exit port has an arcuate shape so as to guide the lid to the exit port from the dispensing block. The ejection arm may be activated by a push lever or a button which when pushed activates an electronic signal to cause the ejection arm to push a lid from the dispenser.

### BRIEF DESCRIPTION OF THE SEVERAL VIEWS OF THE DRAWINGS

FIG. 1 is a perspective view of one embodiment of the lid dispenser of the present invention;

FIG. 2 is a top view of a horizontal cross-section taken along lines 2-2 of FIG. 1;

FIG. 3 is a top view of the same cross-section of FIG. 2 but with a portion of the dispensing mechanism having been activated; and

FIG. 4 is a perspective view of another embodiment of the lid dispenser of the present invention.

### DETAILED DESCRIPTION OF INVENTION

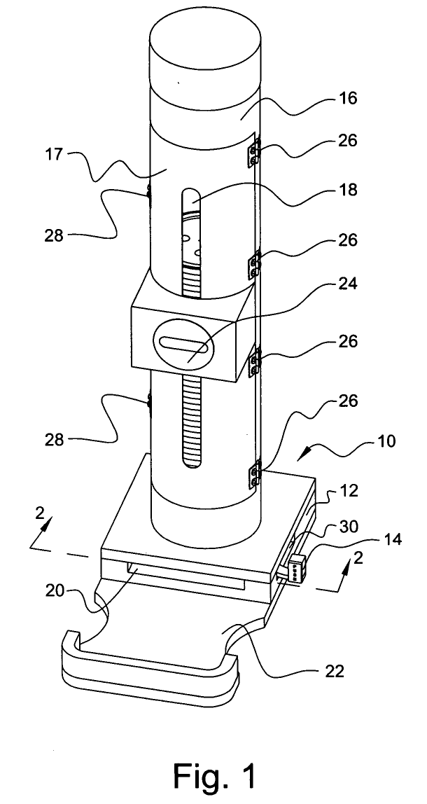

FIG. 1 is a perspective view of a lid dispenser 10. The lid dispenser 10 dispenses one lid at a time which lid is used on cups for soda, coffee, milkshakes and the like. The lids are non-nesting and are placed in a lid stack holder 16 of the lid dispenser 10. An open slit 18 appears in the front or the back of the lid stack holder 16 to allow the supplier to view how many lids are left in the lid stack holder 16 without having to open the lid stack holder 16.

In the embodiment where the open slit 18 appears in the front of the lid stack holder 16 there are hinges 26 which allow the front portion 17 of the lid stack holder 16 to open in order to restock the stack of lids. The front portion 17 is secured by latches 28 to prevent opening after restocking of the lids to the lid stack holder 16. Preferably a label 24 shows the size of the lid on the front of the lid stack holder. However, designation of the size of the lid may be placed anywhere in the vicinity of the lid dispenser 10.

The lid stack holder 16 is affixed to a dispensing block 12. Preferably the lid stack holder 16 is affixed to the dispensing block 12 by a screw on mechanism (not shown). The lid stack holder 16 has an opening ( not shown) in the bottom to allow the stack of lids to rest on the floor of the dispensing block 12. The lid dispensing block 12 ejects lids one at a time upon activation of the push lever 14. The push lever 14 moves backward in a slot 30 provided in the dispensing block 12. The lid (not shown) is ejected through an opening 20, and when ejected lands on a tray 22. The tray 22 holds the expelled lid until the customer picks it up.

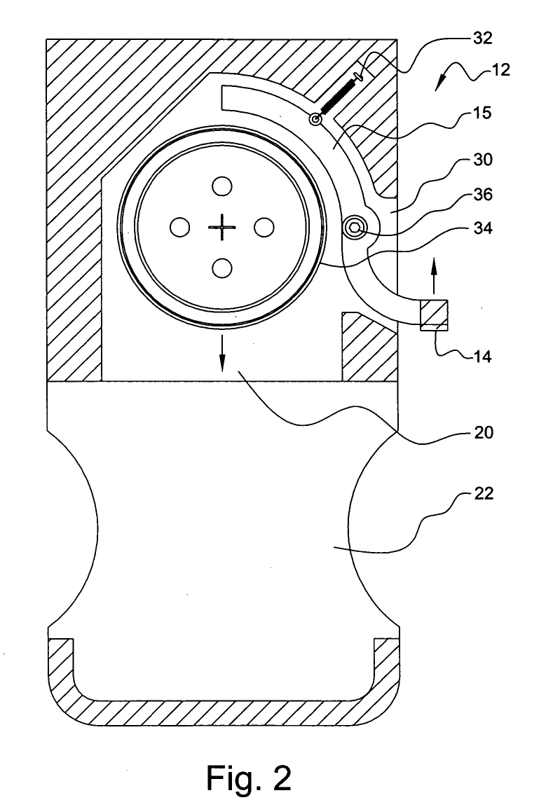

FIG. 2 is an exploded top view of a horizontal cross section along lines 2-2 of FIG. 1 of the interior of the dispensing block 12. A push lever 14 when activated, is moved backward in the direction shown by the arrow. The push lever 14 is anchored by a pivot pin 36 or other pivoting means such as a screw so that an ejection arm 15 of the push lever 14 rotates as depicted by the arrows toward an exit port 20. The push lever 14 is returned to its original position by a spring 32 or a like mechanism and can be immediately activated to expel another lid 34.

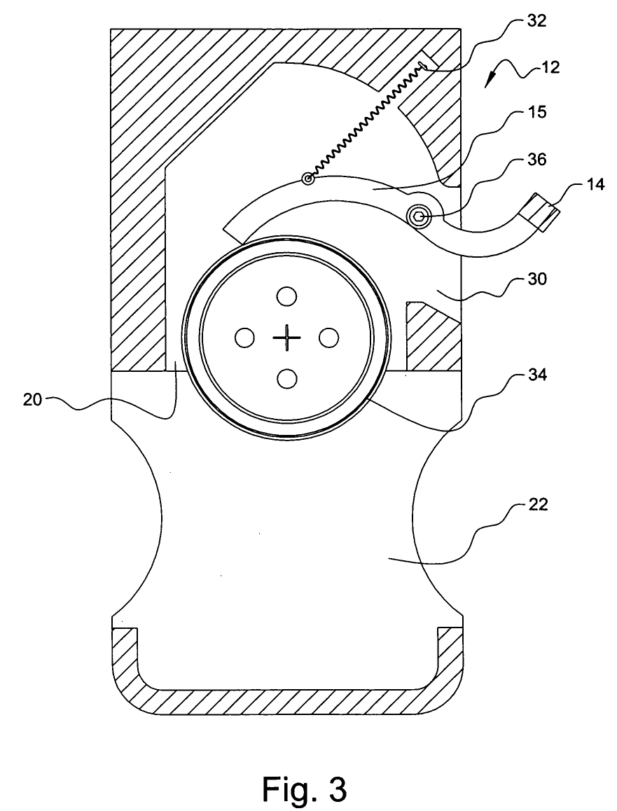

FIG. 3 is an exploded cross-sectional view of FIG. 1 along lines 2-2 depicting the lid dispenser 10 in the act of dispensing a lid 34. The ejection arm 15 contacts a lid 34 and expels a lid 34 from the dispensing block through the exit port 20 and onto a tray 22. The push lever 14 has been activated and the ejection arm 15 has been pivoted so as to eject a lid 34 from the dispensing block through the exit port 20 and onto the tray 22. The spring mechanism 32 attached to the ejection arm 15 will return the ejection arm 15 to the starting point when the push lever 14 is released by the user. The pivot pin 36 in the ejection arm 15 can be any suitable screw, pinion, or the like which allows the push lever 14 and ejection arm 15 to rotate about the pivot pin 36. The lid 34 is expelled through the exit port 20 onto the tray 22. The lid 34 remains on the tray until the customer picks it up for use.

The push lever 14 is returned to its original position by a spring 32 or by any other suitable means and is immediately ready to be activated to expel another lid 34.

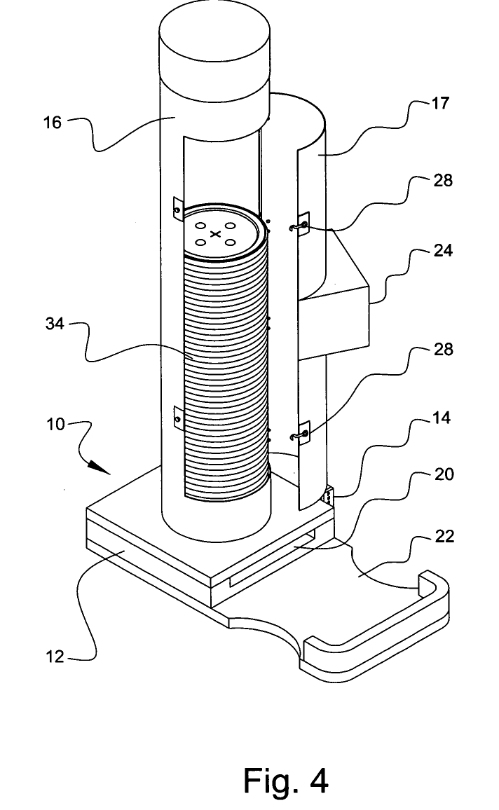

FIG. 4 is a perspective view of one embodiment of the present invention. In this view the lid dispenser 10 has a lid stack holder 16 which in turn has a front portion 17 which can be opened by unlatching latches 28 and opening the front portion on the hinges 26 (not shown). This enables a supplier of lids 34 to replenish the stack of lids for continued use of the lid dispenser 10. The front portion of the lid stack holder 16 may contain a label 24 depicting the size of the lids 34 in the lid stacker 16.

The lid dispenser 10 may be made of any suitable material e.g. wood, plastic, injection molded material or the like which will allow the mechanism discussed above to perform its function of dispensing one lid at a time from the lid dispenser 10. The lid dispenser 10 should contain non-nesting lids in order to allow the dispensing mechanism to eject one lid 34 at a time. The lid dispenser 10 may be mounted on its side or in a vertical position or if necessary upside down but in such cases, a spring mechanism to maintain the lids in a stack rather than just gravity feeding the lids, would be necessary.

The same lid dispenser 10 can be used for lid stacks of different sizes so long as the dispensing mechanism will discharge one lid at a time. Consequently, it is not necessary to have a separate lid dispenser for each lid size that a store may stock. However, it is recommended only one size of lid should be used in each lid stack holder 16 within the lid dispenser 10.

Blocks of multiple lid dispensers 10 may be used wherein each dispenser has a different size lid 34.

Although the invention has been described in considerable detail in the foregoing, it is to be understood that such detail is solely for the purpose of illustration and that variations can be made without departing from the spirit and scope of the invention.

1. A dispenser for non-nesting lids comprising a lid stack holder mounted on a lid dispensing block, the block having a push lever on a pivoting ejection arm, the arm having an arcuate shape to guide a lid to an exit port for ejection from the dispensing block through the exit port.

2. The dispenser of claim 1 wherein the ejection arm is returned to its start position by a spring.

3. The dispenser of claim 1 having a tray attached near the exit port upon which the lid falls upon ejection.

4. The dispenser of claim 1 wherein the lid stack holder has a slot in front or back to allow a view of the quantity of lids in the holder.

5. The dispenser of claim 1 wherein the front of the lid stack holder has a door which can be opened to replace the stack of lids.

6. A lid dispenser which comprises:
(a) a lid stack holder for containing a stack of non-nesting lids, an opening in the bottom of the lid stack holder, the holder being mounted on
(b) a lid dispensing block: having
i. a push lever on a pivoting ejection arm, the arm having an arcuate shape;
ii. an exit port for ejection of a lid from the dispensing block; and
iii. means to return the ejection arm to its original position.

7. The dispenser of claim 6 wherein the lid stack holder has a slot in front or back to allow a view of the quantity of lids in the holder.
